(19) United States
(12) Patent Application Publication
(10) Pub. No.: US 2014/0285670 A1
(43) Pub. Date: Sep. 25, 2014

(54) PHOTOGRAPHING DEVICE, PHOTOGRAPHING METHOD AND COMPUTER READABLE STORAGE MEDIUM

(71) Applicant: CASIO COMPUTER CO., LTD., Tokyo (JP)

(72) Inventor: Ken FUJITA, Tokyo (JP)

(73) Assignee: CASIO COMPUTER CO., LTD., Tokyo (JP)

(21) Appl. No.: 14/220,046

(22) Filed: Mar. 19, 2014

(30) Foreign Application Priority Data
Mar. 22, 2013 (JP) 2013-060504

(51) Int. Cl. H04N 7/18

(52) U.S. Cl. CPC H04N 7/185
USPC 348/158

(57) ABSTRACT

A photographing device includes a photographing unit, a storage unit, a position obtaining unit, a position determining unit and a photographing control unit. The photographing unit photographs a subject and changes a photographing interval. In the storage unit, information of a designated position and a designated photographing interval that are related to each other are stored. The position obtaining unit obtains information of a present position. The position determining unit determines whether the present position is within an area including the designated position. The photographing control unit sets a photographing interval for the designated position and makes the photographing unit take photographs when the position determining unit determines that the present position is within an area including the designated position.

### BACKGROUND OF THE INVENTION

1. Field of the Invention

The present invention relates to a photographing device, a photographing method and a computer readable storage medium.

2. Description of Related Art

Conventionally, a digital camera which carries out intermittent photographing, wherein photographs are taken at a low speed at fixed intervals, has been known.

A camera system which automatically takes photographs under a preset photographing condition when a camera comes to a photographing point is also known (See Patent Document JP2001-257920A for example). In this camera system, positional information for specifying the photographing point and the photographing condition are preset for the camera in advance.

However, when photographs are taken intermittently at fixed long photographing intervals, the digital camera may fail to photograph a subject at a certain photographing point, for example. Also, the above camera, for which the photographing condition is set only for the photographing point, may take many photographs at photographing points which are not significant when a photographing interval is set to a fixed short length. Thereby a storage medium and a battery are wasted.

### SUMMARY OF THE INVENTION

According to a first aspect of the present invention, there is provided a photographing device including: a photographing unit which photographs a subject and which changes a photographing interval; a storage unit in which information of a designated position and a designated photographing interval that are related to each other are stored; a position obtaining unit which obtains information of a present position; a position determining unit which determines whether the present position is within an area including the designated position; and a photographing control unit which sets a photographing interval for the designated position and which makes the photographing unit take photographs when the position determining unit determines that the present position is within an area including the designated position.

According to a second aspect of the present invention, there is provided a photographing method including the steps of: relating and storing information of a designated position and a designated photographing interval; obtaining information of a present position; determining whether the present position is within an area including the designated position; and setting a photographing interval for the designated position and making a photographing unit photograph a subject when determining that the present position is within the area including the designated position.

According to a third aspect of the present invention, there is provided a non-transitory computer readable storage medium having a program stored thereon, the program enabling a computer to function as: a photographing unit which photographs a subject and which changes a photographing interval; a storage unit in which information of a designated position and a designated photographing interval that are related to each other are stored; a position obtaining unit which obtains information of a present position; a position determining unit which determines whether the present position is within an area including the designated position; and a photographing control unit which sets a photographing interval for the designated position and which makes the photographing unit take photographs when the position determining unit determines that the present position is within an area including the designated position.

### BRIEF DESCRIPTION OF THE DRAWINGS

The present invention will become more fully understood from the detailed description given hereinbelow and the appended drawings which are given byway of illustration only, and thus are not intended as a definition of the limits of the present invention, and wherein:

FIG. 1 is a schematic view showing configuration of a photographing system according to an embodiment of the present invention;

FIG. 2 is a block diagram showing functional configuration of a PC;

FIG. 3 is a block diagram showing functional configuration of a photographing device;

FIG. 4 illustrates configuration of settings information;

FIG. 5 illustrates an example of setting of a photographing interval in accordance with latitude and longitude information and with date and time information;

FIG. 6 illustrates an example of setting of a photographing interval in accordance with altitude information and with date and time information;

FIG. 7 is a flowchart of settings input processing executed by a PC and photographing setting processing executed by the photographing device; and

FIG. 8 is a flowchart of intermittent photographing processing executed by the photographing device.

### DETAILED DESCRIPTION OF THE PREFERRED EMBODIMENT

Hereinafter, an embodiment of the present invention will be described with reference to the drawings. Though various technical limitations which are preferable to perform the present invention are included in the after-mentioned embodiment, the scope of the invention is not limited to the following embodiment and the illustrated examples.

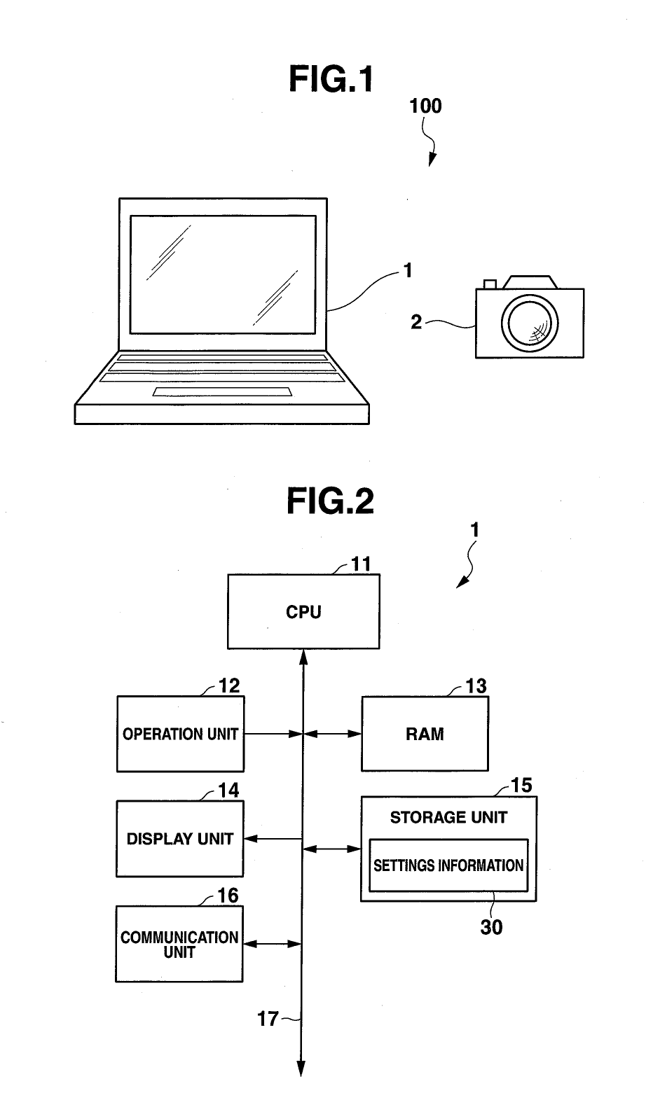

Configuration of a device according to the embodiment will be described referring to FIG. 1 to FIG. 3. First, a photographing system 100 of the embodiment will be explained referring to FIG. 1, which is a schematic view showing configuration of the photographing system 100.

As shown in FIG. 1, the photographing system 100 is provided with a PC (Personal Computer) 1 and a photographing device 2. The PC 1 is a device for setting photographing conditions, such as a photographing interval, of the photographing device 2. The PC 1 is connected to the photographing device 2 via a wireless communication channel such that the PC 1 and the photographing device 2 can communicate with each other. The photographing device 2 is a digital camera capable of intermittent photographing. A user holds and moves the photographing device 2 to take photograph on a hike (mountain-climbing). Though the embodiment explained here is an example in which the photographing device 2 is used to take photographs on a hike, it is not the only example. The photographing device 2 can be used for photographing on touring, bicycle riding, a short trip, etc. The photographing device 2 may be configured so as to be attachable to a user's helmet, motorcycle, etc. or to function as a drive recorder provided on a user's car, etc.

Next, functional configuration in the PC 1 will be explained referring to FIG. 2, which is a block diagram showing functional configuration of the PC 1.

As shown in FIG. 2, the PC 1 includes a CPU (Central Processing Unit) 11, an operation unit 12, a RAM (Random Access Memory) 13, a display unit 14, a storage unit 15 and a communication unit 16. The units or the like of the PC 1 are connected to each other via a bus 17.

The CPU 11 controls the units or the like of the PC 1. The CPU 11 reads a designated program among a variety of programs from the storage unit 15, opens the program in the RAM 13 and executes a variety of processing in cooperation with the opened program.

The operation unit 12 includes a keyboard having keys for inputting a variety of letters, etc. and outputs operation information to the CPU 11 in accordance with input on the keys. The operation unit 12 may include a touch panel on a display panel of the display unit 14 and output operation information to the CPU 11 in accordance with touch input.

The RAM 13 is a storage unit including a volatile semiconductor memory, etc. and includes a work area where a variety of data and a variety of programs are stored.

The display unit 14 is a display unit including the display panel such as a LCD (Liquid Crystal Display) or an EL (Electroluminescent) display and displays a variety of contents on the display panel in accordance with display information which is input from the CPU 11.

The storage unit 15 consists of a HDD (Hard Disk Drive), etc. and stores information of a variety of data and a variety of programs in such a manner that the information can be read or be written. The storage unit 15 stores an intermittent photographing settings input program (not shown in drawings), which will be explained later, and settings information 30.

The communication unit 16 wirelessly communicates with external devices such as photographing device 2 through a communication method of Bluetooth (registered trademark). The communication unit 16 includes a BT module (not shown in drawings) which wirelessly communicates with a BT module 203a (mentioned later) of a wireless processing unit 203 in the photographing unit 2 in accordance with the Bluetooth standard. That is to say, the BT module of the communication unit 16 executes communication settings processing called pairing in advance so that device information and data of a certificate key are exchanged with a communication subject (such as the photographing device 2) using a wireless signal. After that, connection with the communication subject is automatically or semi-automatically made and broken without executing the communication settings processing every time. The communication unit 16 may communicate through another communication method such as wireless LAN (Local Area Network) communication or wire communication using cable connection, and may communicate with the photographing device 2 through the other communication method.

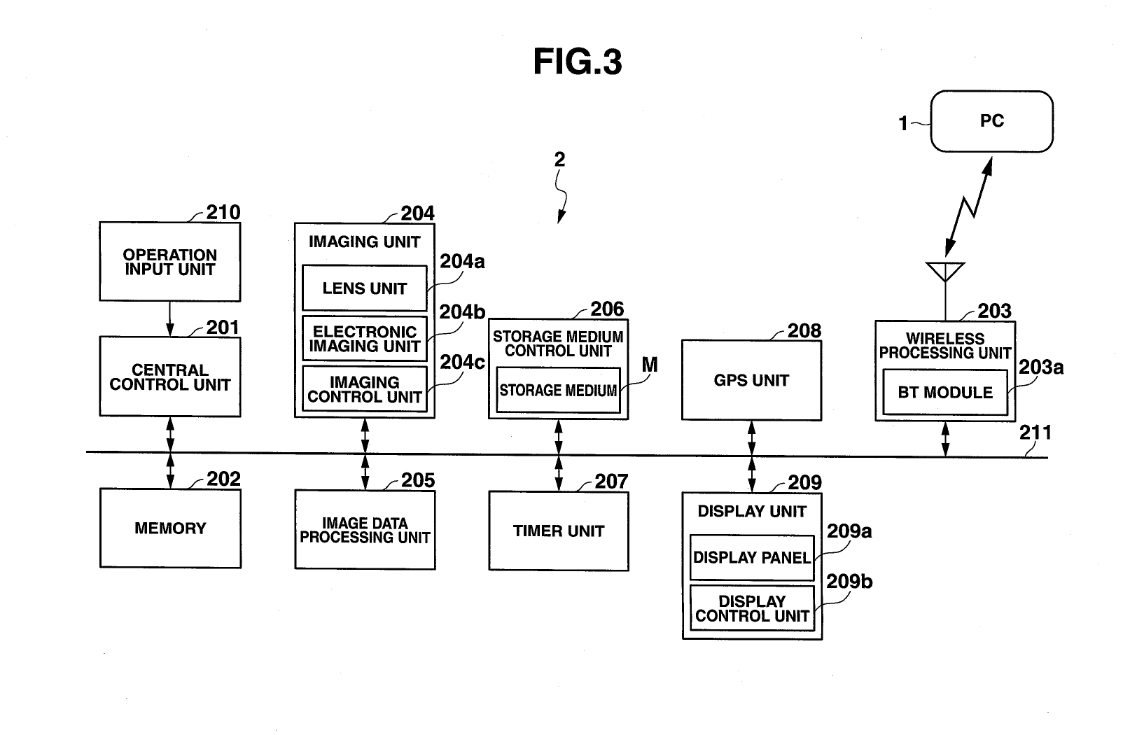

Next, functional configuration inside the photographing device 2 will be explained referring to FIG. 3, which is a block diagram showing functional configuration of the photographing device 2.

As shown in FIG. 3, the photographing device 2 includes a central control unit 201 as a position determining unit, a photographing control unit and a manual photographing determining unit, a memory 202, the wireless processing unit 203, an imaging unit 204, an image data processing unit 205, a storage medium control unit 206, a timer unit 207 as a means for obtaining data and time information, a GPS (Global Positioning System) unit 208 as a means for obtaining positional information, a display unit 209 and operation input unit 210. The central control unit 201, the memory 202, the wireless processing unit 203, the imaging unit 204, the image data processing unit 205, the storage medium control unit 206, the timer unit 207, the GPS unit 208 and the display unit 209 are connected via a bus line 211.

The central control unit 201 controls each part of the photographing device 2. Specifically, the central control unit includes, for example, a CPU, a RAM and a ROM which are not shown in drawings, and executes a variety of control operations in accordance with a variety of processing programs (not shown in drawings) for the photographing device 2 which are stored in the ROM. The CPU reads a variety of programs from the ROM and opens the programs in the RAM 13. The central control unit 201 executes a variety of processing through cooperation of the opened programs and the CPU. In this while, the CPU stores results of a variety of processing in a storage area of the RAM, and, if necessary, displays the results on the display unit 209.

The RAM includes a program storage area, a data storage area, etc. Processing programs, etc. which are executed by the CPU are opened in the program storage area. Input data, processing results which are generated when the above processing programs are executed, etc. are stored in the data storage area. The ROM stores programs stored in a form of a computer-readable program code, specifically, system programs which can be executed by the photographing device 2, a variety of processing programs which can be executed by the system programs, data used when these variety of processing programs are executed, etc. The ROM stores at least an intermittent photographing setting program and an intermittent photographing program which will be explained later.

The memory 202 consists of, for example, a DRAM, etc. and temporarily stores data such as data executed by the central control unit 201.

The wireless processing unit 203 wirelessly communicates with the PC 1 which is connected via a predetermined wireless communication line. Specifically, the wireless processing unit 203 includes a Bluetooth module (BT module) 203a for example.

In approximately the same manner as the BT module (not shown in drawings) of the communication unit 16 in the PC 1 for example, the BT module 203a wirelessly communicates with the communication unit 16 of the PC 1 in accordance with the Bluetooth standard.

The imaging unit 204 constitutes an imaging means which images a subject. Specifically, the imaging unit 204 includes a lens unit 204a, an electronic imaging unit 204b and an imaging control unit 204c.

The lens unit 204a consists of a plurality of lenses such as a zoom lens, a focus lens, etc. The electronic imaging unit 204b consists of an image sensor such as a CCD (Charge Coupled Device) or a CMOS (Complementary Metal-oxide Semiconductor) and converts an optical image into a two-dimensional image signal, the optical image having passed the variety of lenses of the lens unit 204a. The imaging unit 204 may be provided with an aperture stop (not shown in drawings) which adjusts an amount of light passing through the lens unit 204a.

The imaging control unit 204c controls imaging of a subject by the electronic imaging unit 204b. The imaging control unit 204c includes a timing generator, a driver, etc. which are not shown in drawings. The timing generator and the driver of the imaging control unit 204c drive the electronic imaging unit 204b to perform scanning. The electronic imaging unit 204b converts optical images into two-dimensional image signals at predetermined intervals, the optical image having been formed by the lens unit 204a. Then the imaging control unit 204c reads each frame image for one screen from an imaging area of the electronic imaging unit 204b and makes the image data processing unit 205 output the frame image.

The image data processing unit 205 generates image data of a subject. That is to say, the image data processing unit 205 processes frame images one after another, the frame images having been imaged by the imaging unit 204. Specifically, as the occasion demands, the image data processing unit 205 adjusts gain of each color component of RGB in an analog signal of each frame image which is forwarded from the electronic imaging unit 204b at predetermined intervals corresponding to a photographing interval. Then the image data processing unit 205 executes sampling and holding by a sample and hold circuit (not shown in drawings), executes conversion into a digital data by an A/D converter (not shown in drawings), and executes color processing including pixel interpolation processing and y correction processing by a color processing circuit (not shown in drawings). Then the image data processing unit 205 generates a digital brightness signal Y and color difference signals Cb, Cr (YUV data). Thus the imaging unit 204 and the image data processing unit 205 take photographs in accordance with a set photographing interval and generate frame images to function as a photographing means.

Also, the image data processing unit 205 compresses the YUV data of frame images in a predetermined encoding format (such as the JPEG format) and outputs the compressed data to the storage medium control unit 206.

The storage medium control unit 206 includes a detachable storage medium M as a storage means and controls reading of data from the attached storage medium M and writing of data on the storage medium M. That is to say, the storage medium control unit 206 stores image data of frame images for storage in a predetermined storage area of the storage medium M, the image data being encoded in a predetermined compression format (such as the JPEG format, the Motion JPEG format and the MPEG format) by an encoding section (not shown in drawings) of the image data processing unit 205. The storage medium M consists of a non-volatile memory (flash memory), etc. for example.

The timer unit 207 includes, for example, a timer circuit, etc. which are not shown in drawings. The timer unit 207 times the present date and time, generates date and time information and outputs the date and time information to the central control unit 201.

The GPS unit 208 includes an antenna which receives GPS signals from GPS satellites. The GPS unit 208 calculates present latitude and longitude information and altitude information of the photographing device 2 using the received GPS signals, and output the information to the central control unit 201. The latitude and longitude information can be calculated from three GPS signals from three GPS satellites. The GPS unit 208 receives and uses four GPS signals from four GPS satellites so that not only the latitude and longitude information but also the altitude information can be calculated. The timer unit 207 may receive a GPS signal to time the date and time information using time information in the GPS signal.

The display unit includes a display panel 209a and a display control unit 209b. The display panel 209a displays an image on a display screen. For example, a liquid crystal display panel, an organic electroluminescent display panel, etc. can be adopted as the display panel 209a. However, these are only a part of examples, and many others can be adopted.

The display control unit 209b reads image date for displaying which is temporarily stored in the memory 202 and controls the display panel 209a to display a predetermined image on the display screen on the basis of image date of a predetermined size which is decoded by the image data processing unit 205. Specifically, the display control unit 209b includes a VRAM (Video Random Access Memory), a VRAM controller, a digital video encoder, etc. (not shown in drawings). The digital video encoder reads the brightness signal Y and the color difference signals Cb, Cr, which are encoded by the image data processing unit 205 and which are stored in the VRAM, at a predetermined playing frame rate (such as 30 fps) from the VRAM via the VRAM controller. Then the digital video encoder generates a video signal on the basis of these data and outputs the video signal to the display panel 209a.

The operation input unit 210 is used to carry out a predetermined operation of the photographing device 2 and includes, for example, a power source button for turning on/off a power source of the device body, a shutter button for instructing imaging of a subject, a selection button for instructing selection of a photographing mode, a function, etc., a zoom button for instructing adjustment of zoom (not shown in drawings), etc. The operation input unit 210 outputs a predetermined operation signal to the central control unit 201 in accordance with operation of the buttons.

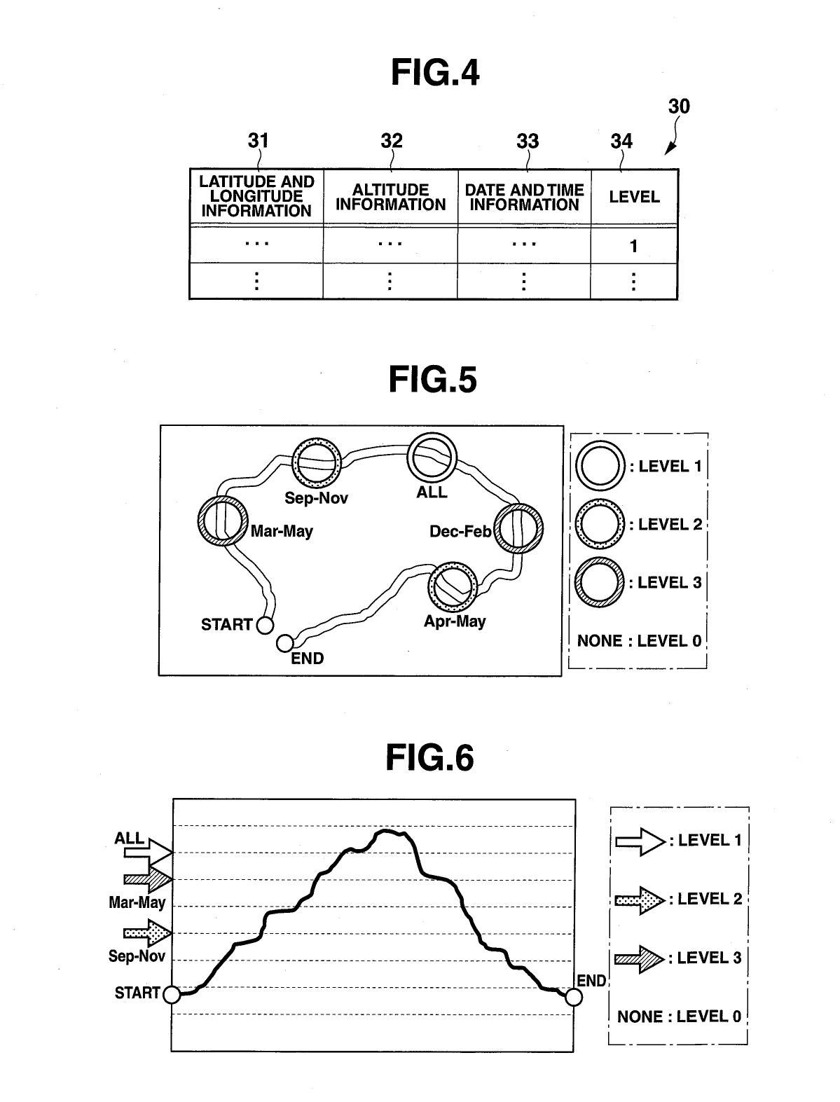

Next, configuration of the settings information 30 will be explained referring to FIG. 4 to FIG. 6. FIG. 4 shows configuration of the settings information 30. FIG. 5 shows an example of setting of a photographing interval in accordance with latitude and longitude information and with date and time information. FIG. 6 shows an example of setting of a photographing interval in accordance with altitude information and with date and time information.

The settings information 30 is a table for setting a level of a photographing interval in intermittent photographing. As shown in FIG. 4, the settings information 30 includes items of latitude and longitude information 31, altitude information 32, data and time information 33 and a level 34.

The latitude and longitude information 31 indicates latitude and longitude of a designated position. The latitude and longitude information 31 may indicate ranges of latitude and longitude of a designated area.

The altitude information 32 indicates altitude of a designated position. The altitude information 32 may indicate a range of altitude of a designated position.

The date and time information 33 indicates a designated date and time. The date and time information 33 may indicate year and month in addition to date and time. Further, the date and time information 33 may indicate a range of a designated date and time.

The level 34 indicates a level of a photographing interval in intermittent photographing corresponding to a photographing position and to the date and time information 33. The photographing position corresponds to the latitude and longitude information 31 and to the altitude information 32. For example, the level 34 includes preset four stages of Level 1: photographing interval 5 sec, Level 2: photographing interval 10 sec, Level 3: photographing interval 30 sec and Level 0: photographing interval 1 min. Level 0 is an ordinary photographing interval. When a demand for preventing failure in photographing a subject is stronger, Level of a shorter photographing interval is selected.

Each designated position, date and time at which a shorter photographing interval is preferred are set for the latitude and longitude information 31, the altitude information 32 and the date and time information 33. Either of Levels 1 to 3 is set for the level 34 of the record. That is to say, Level 0 is not set in the settings information 30. Level 0 is considered to be set for each position, date and time in the settings information 30.

At least one of the latitude and longitude information 31, the altitude information 32 and the date and time information 33 (“AND” condition when plural), and the level 34 are needed to be set for each record in the settings information 30. It is also possible that at least two of the latitude and longitude information 31, the altitude information 32 and the date and time information 33 are set in “OR” condition.

An example of setting for the settings information 30 will be explained. In this example, as shown in FIG. 5, a user takes photographs intermittently while moving along a travel route on a map on which a starting point (START) and an ending point (END) are set. Designated positions of Levels 1 to 3 and months for photographing at each position are shown on the travel route. “ALL” means all the months. The latitude and longitude information 31, the date and time information 33 and the level 34 are set in the settings information 30. The center point of each circle in FIG. 5 is set in the latitude and longitude information 31. An area including a designated position is defined by a circle around the center point with a predetermined radius. When the user enters each circle in FIG. 5 in corresponding months, photographs are taken intermittently at a corresponding Level 1, 2 or 3. In areas other than all the circles in FIG. 5, photographs are taken intermittently at Level 0.

Another example of setting for the settings information 30 will be explained. In this example, as shown in FIG. 6, a user takes photographs intermittently while moving along a travel route on which a starting point (START) and an ending point (END) are set. The travel route is on a plane constituted by a longitudinal axis of altitude and by a transverse axis of a position in a horizontal direction. Designated positions of Levels 1 to 3 and months for photographing at each position are shown on the travel route. The altitude information 32, the date and time information 33 and the level 34 are set in the settings information 30. Altitude of each arrow in FIG. 6 is set in the altitude information 32. An area including a designated position is defined by altitude range between two altitudes—one is higher and the other is lower than the set altitude by a predetermined amount. When the user enters altitude range of each arrow in FIG. 6 in corresponding months, photographs are taken intermittently at a corresponding Level 1, 2 or 3. In areas other than altitude range of all the arrows in FIG. 6, photographs are taken intermittently at Level 0.

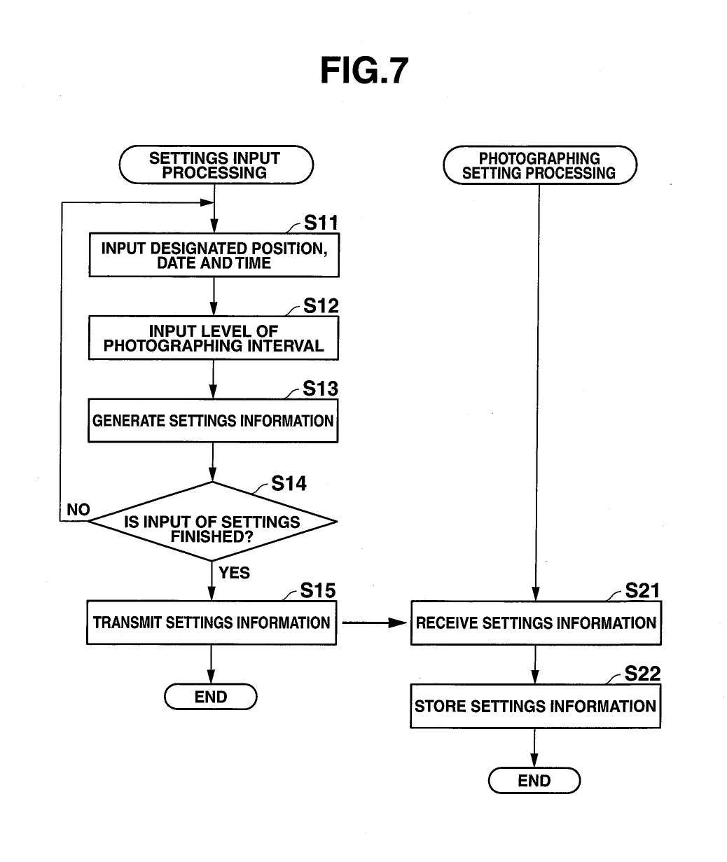

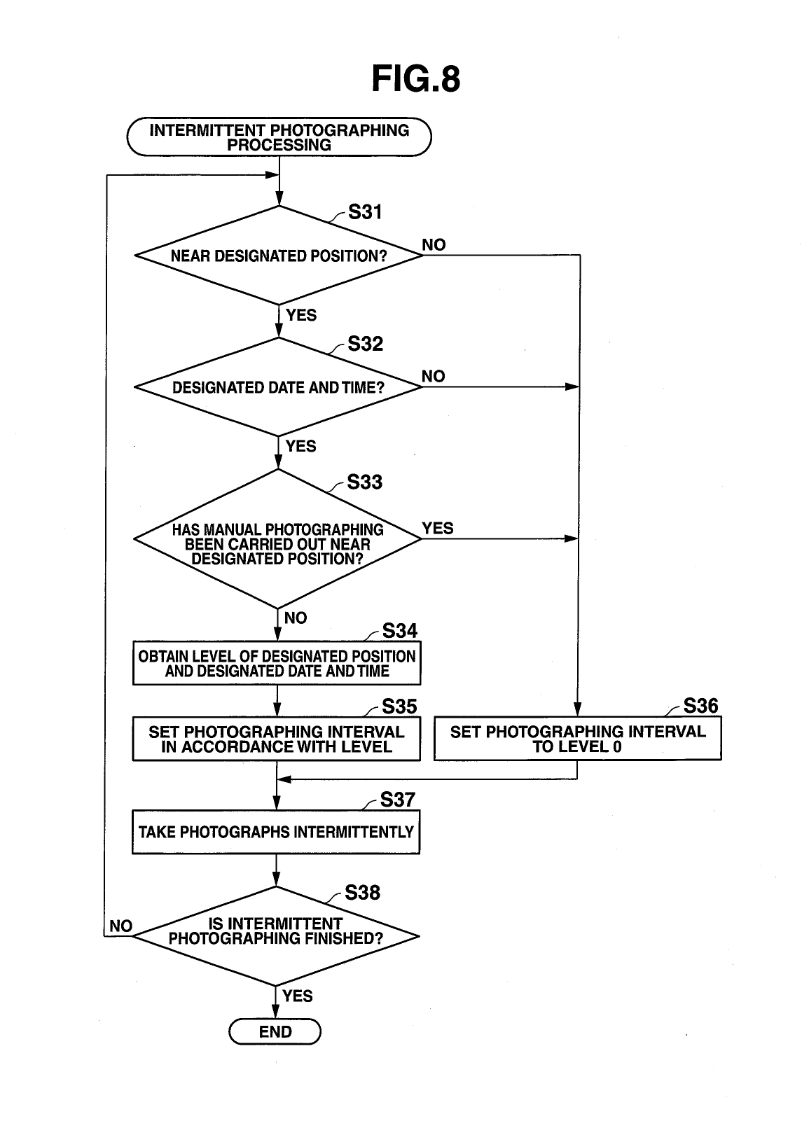

Next, operation of the photographing system 100 will be explained referring to FIG. 7 and FIG. 8. FIG. 7 is a flowchart of settings input processing executed by the PC 1 and photographing setting processing executed by the photographing device 2. FIG. 8 is a flowchart of intermittent photographing processing executed by the photographing device 2.

The settings input processing executed by the PC 1 and the photographing setting processing executed by the photographing device 2 will be explained referring to FIG. 7. First, the settings input processing will be explained. The settings input processing is processing wherein the settings information 30 is generated in advance and is transmitted to the photographing device 2 before a user goes on a hike where intermittent photographing is carried out.

When a user input a command for executing the settings input processing via, for example, the operation unit 12, the CPU 11 of the PC 1 executes the settings input processing in cooperation with an intermittent photographing settings input program which is read from the storage unit 15 and is opened in the RAM 12 according to circumstances.

First, the CPU 11 accepts information of a designated position (latitude, longitude and altitude) and a designated date and time at which intermittent photographing with a photographing interval different from ordinary photographing is carried out. The information is input by a user through the operation unit 12 (Step S11). If a designated date and time is not input in Step S11, the date and time information is not designated.

Then the CPU 11 accepts a level of a photographing interval corresponding to the information of the designated position (latitude, longitude and altitude) and the designated date and time which is input by the user through the operation unit 12 at Step S11 (Step S12). At Step S12, Level 1, 2 or 3 are input.

Then the CPU 11 generates the settings information 30 or add a record thereof on the basis of information of designated latitude and longitude, designated altitude and designated date and time input at Step S11 and of a level input at Step S12 (Step S13). At Step S13, the CPU 11 generates the settings information 30 including a record wherein designated latitude and longitude, designated altitude, a designated date and time, and a level, which have been input, correspond to the latitude and longitude information 31, the altitude information 32, the date and time information 33 and the level 34, or adds the record to the existing settings information 30.

Then the CPU 11 determines whether to end input of settings in accordance with whether the user inputs a command through the operation unit 12 (Step S14), the command being for ending input of photographing position information, etc. When the CPU 11 determines not to end input of settings (Step S14: NO), the processing proceeds to Step S11.

When determining to end input of settings (Step S14: YES), the CPU 11 stores the settings information 30 generated at Step S13 in the storage unit 15, transmit the settings information 30 to the photographing device 2 via the communication unit 16 (Step S15), and ends the settings input processing.

The photographing setting processing executed by the photographing device 2 will be explained referring to FIG. 7. First, the photographing setting processing will be explained. The photographing setting processing is processing wherein the settings information 30 is received from the PC 1 for storing.

When a user input a command for executing the photographing setting processing via, for example, the operation unit 210, the central control unit 201 of the photographing device 2 executes the photographing setting processing through cooperation of a CPU and an intermittent photographing setting program which is read from a ROM and is opened in a RAM according to circumstances.

First, in response to Step S15, the central control unit 201 receives the settings information 30 from the PC 1 via the wireless processing unit 203 (Step S21). Then the central control unit 201 controls the storage medium control unit 206 to store the settings information 30, which has been received at Step S21, in the storage medium M (Step S22), and ends the photographing setting processing.

Next, the intermittent photographing processing executed by the photographing device 2 will be explained referring to FIG. 8. The intermittent photographing processing is processing wherein intermittent photographing at photographing intervals in accordance with a photographing position, a date and time is carried out on a travel route for hiking. A user holds the photographing device 2 which stores the settings information 30 in the storage medium M in advance, and the user hikes along the travel route.

Manual photographing can be carried out with the photographing device 2 in accordance with operation input by a user through the operation input unit 210. When manual photographing is carried out, the central control unit 201 obtains photographing position information (latitude, longitude and altitude) of manual photographing obtained from the GPS unit 208 and date and time information of manual photographing obtained from the timer unit 207, relates the photographing position information of manual photographing to the date and time information, and stores the information as history information in the memory 202.

In intermittent photographing of the embodiment, the photographing device 2 is fixed with a tripod, etc. at a predetermined position of a spot which a user chooses at will. A predetermined number of photographs are taken at predetermined photographing intervals at a fixed position. However, this is not the only way. For example, a user may hold the photographing device 2 to take photographs intermittently.

When a user inputs a command for executing the intermittent photographing processing via, for example, the operation input unit 210, the central control unit 201 of the photographing device 2 executes the intermittent photographing processing through cooperation of the CPU and an intermittent photographing program which is read from the ROM and is opened in the RAM according to circumstances.

First, the central control unit 201 refers to the latitude and longitude information 31 and the altitude information 32 in the settings information 30 stored in the storage medium M, obtains information of a present position (latitude, longitude and altitude) from the GPS unit 208, and determines whether the present position is near a designated position (an area including the latitude and longitude information 31 and the altitude information 32) (Step S31). At Step S31, whether the present position is within, for example, a circle area with the center thereof at a designated position as shown in FIG. 5 or a predetermined range (area) including a designated altitude as shown in FIG. 6 is determined.

When determining that the present position is near the designated position (Step S31: YES), the central control unit 201 refers to the date and time information 33 in the settings information 30, obtains information of a present date and time from the timer unit 207, and determines whether the present date and time agrees with (or is included in) a designated date and time (Step S32).

When determining that the present date and time agrees with the designated date and time (Step S32: YES), the central control unit 201 refers to the history information of manual photographing in the memory 202, and determines whether manual photographing is carried out near a designated position (an area including the designated position) obtained at Step S31 (Step S33). When determining that the manual photographing is not carried out (Step S33: NO), the central control unit 201 refers to the settings information 30, and reads and obtains the level 34 corresponding to the latitude and longitude information 31, the altitude information 32 and the date and time information 33 corresponding to the designated position and the designated date and time obtained at Steps S31 and S32 (Step S34).

Then the central control unit 201 sets a photographing interval of the imaging unit 204 and the image data processing unit 205 to the level 34 obtained in Step S34 (Step S35). When manual photographing is carried out (Step S33: YES), it is estimated that there is no possibility of failing to photograph a subject by manual photographing, and the central control unit 201 sets a photographing interval of the imaging unit 204 and the image data processing unit 205 to an ordinary photographing interval of Level 0 (Step S36). The processing of Step S36 is executed also when the present position is not near a designated position (Step S31: NO) and when the present date and time does not agree with a designated date and time (Step S32: NO).

Then the central control unit 201 controls the imaging unit 204, the image data processing unit 205 and the storage medium control unit 206 to take photographs intermittently at the photographing intervals set at Step S35 or S36 and to store obtained frame images in the storage medium M (Step S37).

Then the central control unit 201 determines whether to end intermittent photographing in accordance with whether a user inputs a command for ending intermittent photographing through the operation input unit 210 (Step S38). When the central control unit 201 determines not to end intermittent photographing (Step S38: NO), the processing proceeds to Step S31. When the central control unit 201 determines to end intermittent photographing (Step S38: YES), the intermittent photographing processing is ended.

As described above, according to the embodiment, the photographing device 2 includes the imaging unit 204 which images a subject and which changes an imaging interval, the image data processing unit 205, the storage medium M which stores the settings information 30 wherein information of each designated position is related to a level of a photographing interval, the GPS unit 208 which obtains information of a present position, and the central control unit 201. The central control unit 201 determines whether the present position is within an area including a designated position in the settings information 30. When determining that the present position is within an area including a designated position in the settings information 30, the central control unit 201 sets a photographing interval to the level 34 corresponding to the designated position in the settings information 30, and makes the imaging unit 204 and the image data processing unit 205 image. Accordingly, at each area including a designated position, a photographing interval is shorter (Level 1, 2 or 3) than a photographing interval in ordinary photographing (Level 0). The storage medium and a battery are efficiently used. Further, missing of photographing a subject in each area including a designated position is reduced.

Also, the photographing unit 2 includes the timer unit 207 which obtains information of present date and time. The storage medium M stores the settings information 30 wherein information of designated position and information of a designated date and time are related to levels of a photographing interval. The central control unit 201 determines whether the present date and time agrees with a designated date and time and, at the same time, the present position is within an area including a designated position in the settings information 30. Accordingly, at each area including a designated position at a designated date and time, a photographing interval is shorter (Level 1, 2 or 3) than a photographing interval in ordinary photographing (Level 0). The storage medium and a battery are efficiently used. Further, missing of photographing a subject in each area including a designated position at a designated date and time is reduced.

The information of a designated position includes at least one of latitude and longitude information and altitude information. Therefore the information can be designated in various ways. Also, at each area including a position of designated latitude, longitude and altitude, a photographing interval is shorter (Level 1, 2 or 3) than a photographing interval in ordinary photographing (Level 0). The storage medium and a battery are efficiently used. Further, missing of photographing a subject in each area is reduced.

When determining that the present position is within an area including a designated position, the central control unit 201 determines whether manual photographing has been carried out in the area. When determining that manual photographing has been carried out in the area, the central control unit 201 sets a photographing interval to an interval in ordinary photographing and makes the imaging unit 204 and the image data processing unit 205 take photographs. Accordingly, when it is estimated that a subject has been manually photographed, photographing is carried out at photographing intervals in ordinary photographing. Thereby the storage medium and a battery are efficiently used (a data amount of images and a consumed quantity of electricity are reduced).

The storage medium M stores the settings information 30 wherein a plurality of information of a designated position are related to levels of a photographing interval. When determining that the present position obtained by the GPS unit 208 is not within an area including a designated position, the central control unit 201 sets a photographing interval to an interval (Level 0) longer than an interval corresponding to the stored positional information and makes the imaging unit 204, etc. take photographs. Thus, at areas other than each area including the designated positional information, photographs are taken at photographing intervals for ordinary photographing so that the storage medium and a battery are efficiently used.

The present invention is not limited to the above embodiment. Changes and modifications may be made within the scope of the present invention.

For example, the PC 1 generates the settings information 30 in the above embodiment, but the present invention is not limited to this. For example, the PC 1 is connected to a server (not shown in drawings) so as to communicate with the server, and the server generates the settings information 30. Specifically, the server is connected to at least one PC. Each PC accepts information of a designated position, a designated date and time and a level that are input by operation, and transmit the information to the server. The server generates the settings information 30 as a database on the basis of the information received from each PC. The PC 1 downloads the settings information 30 from the server and transmits the settings information 30 to the photographing device 2 for storing. The settings information 30 may include additional information such as information concerning sightseeing attractions on a travel route of a user, information that scenery does not change for a part of the travel route, information that some point on the travel route worth seeing in certain season or in certain period of time, etc.

In the above embodiment, the PC 1 is used as a setting device for the settings information 30, but the present invention is not limited to this. For example, other information processing device such as a smartphone, a tablet terminal, etc. can be adopted as the setting device for the settings information 30. Also, the photographing device 2 itself may set the settings information 30.

In the above embodiment, Level 0, which indicates a photographing interval in an ordinary photographing, is fixed, but the present invention is not limited to this. For example, when a battery (not shown in drawings) of the photographing device 2 is short of power, or when the storage medium M is short of storage area, a photographing interval in ordinary photographing is made longer. Each case has an effect that battery power or an available storage area of the storage medium M is saved.

In the above embodiment, the photographing device 2 takes photographs intermittently while changing a photographing interval. However, the present invention is not limited to this. In addition to a photographing interval, other matters may be changed—for example, picture quality, whether to record sound, etc. Further, the photographing device 2 may execute video shooting or consecutive shooting while changing FPS (Frames per Second).

In the above embodiment wherein video shooting or consecutive shooting is executed, the central control unit 201 of the photographing device 2 may determine whether photographs are taken under a predetermined photographing condition. When photographs are taken under a predetermined photographing condition, a photographing interval may be set to a shorter length than an interval when photographs are taken not under the predetermined photographing condition. A predetermined photographing condition is, for example, a photographing condition under which pictures are taken in improved picture quality or a photographing condition under which a photograph image is stored with sound information which is recorded while the image is obtained. According to this example, motions of animation can be smoothly reproduced in a significant photographing part in which a photographing interval should be made shorter.

In the above embodiment, the central control unit 201 executes the intermittent photographing processing in cooperation with a program, but the present invention is not limited to this. The photographing device 2 may include a circuit for exclusive use, such as a logic circuit, which executes the same processing as the intermittent photographing processing.

In the above embodiment, a ROM and a hard disc are used as a computer-readable medium which stores a program for executing each processing. In addition, a non-volatile memory such as a flash memory and a portable storage medium such as a CD-ROM can be adopted. As a medium which provides program data via a predetermined communication line, a carrier wave can be adopted.

It should be understood that changes and modifications may be made in the detailed configurations and operations of the components of the photographing system according to the above embodiment without departing from the spirit of the present invention.

While the embodiment of the present invention is described, the scope of the present invention is not intended to be limited to the above-described embodiment, but is defined by scope of the claims including the full scope of their equivalents.

This U.S. patent application claims priority to Japanese patent application No. 2013-060504 filed on Mar. 22, 2013, the entire contents of which are incorporated by reference herein for correction of incorrect translation.

What is claimed is:

1. A photographing device, comprising:
a photographing unit which photographs a subject and which changes a photographing interval;
a storage unit in which information of a designated position and a designated photographing interval that are related to each other are stored;
a position obtaining unit which obtains information of a present position;
a position determining unit which determines whether the present position is within an area including the designated position; and
a photographing control unit which sets a photographing interval for the designated position and which makes the photographing unit take photographs when the position determining unit determines that the present position is within an area including the designated position.

2. The photographing device according to claim 1, further comprising:
a date and time obtaining unit which obtains information of a present date and time,
wherein the storage unit relates information of the designated position and a designated date and time to a photographing interval, and stores the information of the designated position and the designated date and time and the photographing interval, and
wherein the position determining unit determines whether the present date and time agrees with the designated date and time and, at the same time, the present position is within an area including the designated position.

3. The photographing device according to claim 1, wherein the information of the designated position includes either or both of latitude and longitude information and altitude information.

4. The photographing device according to claim 1, further comprising:
a manual photographing determining unit which determines whether manual photographing was carried out in the area including the designated position when the position determining unit determines that the present position is within the area including the designated position,
wherein, when the manual photographing determining unit determines that manual photographing was carried out in the area including the designated position, the photographing control unit sets a photographing interval to an interval in ordinary photographing and makes the photographing unit take photographs.

5. The photographing device according to claim 1,
wherein the storage unit relates and stores a plurality of information of the designated position and a plurality of the designated photographing intervals, and
wherein, when the position determining unit determines that the present position is not within the area including the designated position, the photographing control unit sets a photographing interval to a length longer than the photographing interval for the designated position.

6. A photographing method, comprising the steps of:
relating and storing information of a designated position and a designated photographing interval;
obtaining information of a present position;
determining whether the present position is within an area including the designated position; and
setting a photographing interval for the designated position and making a photographing unit photograph a subject when determining that the present position is within the area including the designated position.

7. A non-transitory computer readable storage medium having a program stored thereon, the program enabling a computer to function as:
a photographing unit which photographs a subject and which changes a photographing interval;
a storage unit in which information of a designated position and a designated photographing interval that are related to each other are stored;
a position obtaining unit which obtains information of a present position;
a position determining unit which determines whether the present position is within an area including the designated position; and
a photographing control unit which sets a photographing interval for the designated position and which makes the photographing unit take photographs when the position determining unit determines that the present position is within an area including the designated position.
